(19) United States
(12) Patent Application Publication
(10) Pub. No.: US 2008/0059314 A1
(43) Pub. Date: Mar. 6, 2008

(54) Managing marketing communications in sales processes

(76) Inventors: Paul Kirchoff, Austin, TX (US); Ryan Addams, Austin, TX (US)

Correspondence Address: Steven Thrasher, 391 Sandhill Dr., Richardson, TX, 75080, US

(21) Appl. No.: 11/899,555

(22) Filed: Sep. 5, 2007

Related U.S. Application Data
(60) Provisional application No. 60/842,250, filed on Sep. 5, 2006.

(51) Int. Cl. G06Q 30/00; G06F 17/00

(52) U.S. Cl. 705/14

(57) ABSTRACT

Disclosed systems, methods, and apparatti generally define subsystems and process that work together to facilitate marketing communication and feedback in a sales process. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

The invention is related to and claims priority from U.S. Provisional Patent Application No. 60/842,250 to Kirchoff, et al., entitled Sales Assistance System and Method filed on 5 Sep. 2006.

### TECHNICAL FIELD OF THE INVENTION

The present invention relates generally to the Internet, and more particularly to marketing communications and services that utilize the internet.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Those organizations engaged in sales and marketing have long struggled to coordinate the ever changing fulfillment of marketing and sales activities throughout the sales process. Properly courting a new prospect requires different sales and marketing tactics than does generating referrals from a past client or a contact in a sales reps network. The sales process and tactics change from company to company and industry to industry. Once chosen, these tactics often require tight synchronization between an independent sales rep that has intimate knowledge of the real-time sales process and a centralized marketing function responsible for providing marketing materials to assist in the sales process. This coordination generally includes employing ever changing marketing materials across different marketing mediums such as email, phone calls, faxes, direct mail and more as the sales process progresses. If a sales person knows the sales process has changed, and there is lag getting information to a marketing group who then sends a communication with a delivery lead time, the marketing communication may be ineffective by the time it is delivered.

Today's sales and marketing personnel use customer relationship management (CRM) software systems to centralize the capture and use of information collected during and after a sales process. Larger organizations struggle to balance the importance of information capture with the time necessary to proactively provide such information during a sales process. A marketing function desires more information to better analyze each step in order to provide more accurate feedback to product teams or provide better sales tools to help increase company performance. Sales individuals, on the other hand, are often compensated only when they close business for the organization and, as such, treat their time as precious, often choosing to spend their time on customer communication activities rather than information reporting. In some cases, only the minimal amount of information is provided and then they are back to focusing on sales.

The smaller the organization, the more this behavior challenge is compounded. In many cases, for small and medium businesses, the sales person must also make marketing decisions but because time must be spent on sales, marketing is ignored, sub-optimized, or done whenever there is a break. And marketing choices may require multiple vendors and their subsequent oversight, which again, competes with time spent on selling activities. Furthermore, many of these marketing pieces, having differing design sources, will have incompatible designs which can further sub-optimize marketing results. And the cost to manage all of these sources can be further burdensome the smaller the organization.

Additionally, marketing or sales actions are many times not tracked for effectiveness which means that optimization decisions may not be possible—especially across differing mediums. These smaller organizations will seek the advice of industry pundits but still bear the burden of execution; directly at odds with their time constraint. Additionally, today's marketing touch points may also be static and must be rebuilt for different uses if information suggests a change could be beneficial.

Therefore, there exists the need for a single system to automatically choose, compose, manage, fulfill, track, report, and bill for marketing communications across any stage of a sales process and via any communication medium based on user, recipient, environment or any other source of data.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 (Prior Art) illustrates a typical sales cycle where each stage contains marketing elements and an algorithm for choosing which marketing action element to send to the fulfillment for execution.

FIG. 2 shows software architecture capable of choosing, composing, fulfilling, tracking, reporting and billing for marketing actions.

FIG. 2a illustrates a subset of the system's Event Scheduler in which data inputs or events can trigger additional action plans which can change the nature of actions previously scheduled to take place.

FIG. 2b illustrates a subset of the system's User Interface and Data Storage System whereby a network of users can assist in keeping each other's contact lists.

FIG. 2c illustrates a subset of the system's User Interface, Tracking and Reporting system whereby a user's use of the system creates a profile searchable by other users of the system.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### Description of the Drawings

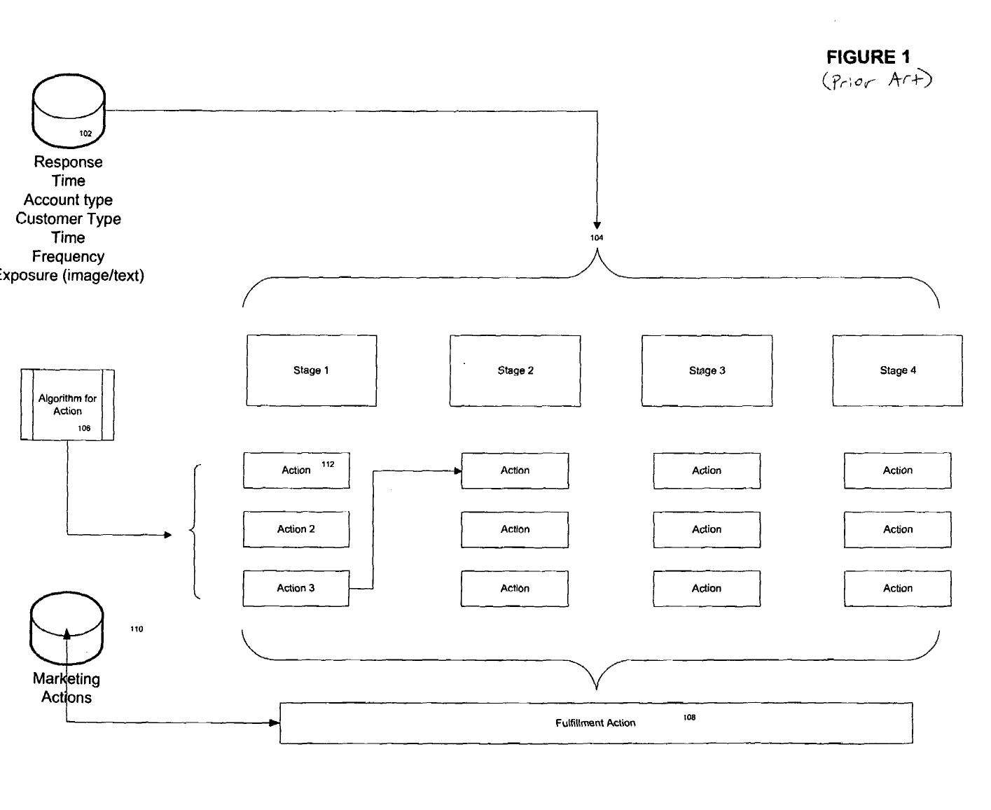

FIG. 1 (Prior Art) provides an example of a company's sales cycle and marketing efforts. Every company has distinct sales stages 104 which vary in number of actions and duration. For example, a sales person may need to create interest, convince the prospect of value, provide a service or deliver a product, and then thank them and try to generate referrals. In each case there may be various marketing/sales actions (collectively, 112) that can take place to assist in convincing the prospect or customer to take action. Based on information captured before, during, or after a process 102, an algorithm for action 106 is invoked which determines which marketing/sales action(s) to perform. Once the correct action is taken, a fulfillment action 108 is necessary to execute or send the correct set of marketing action inputs to the recipient 110.

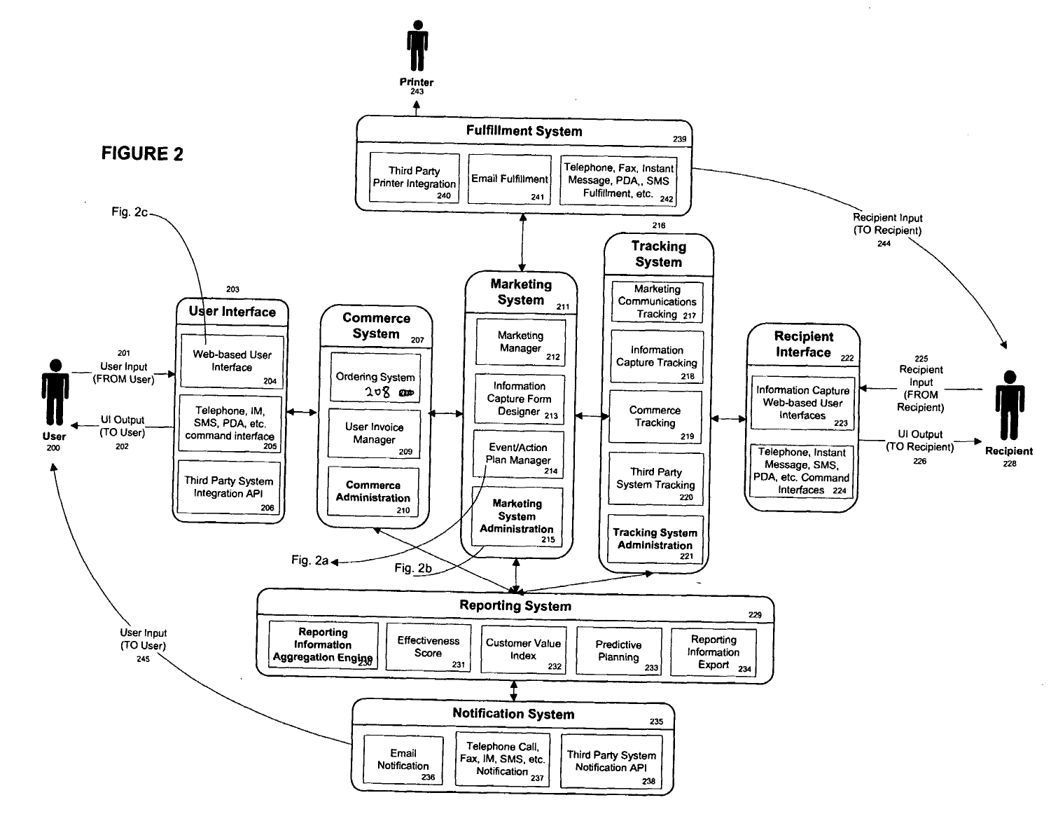

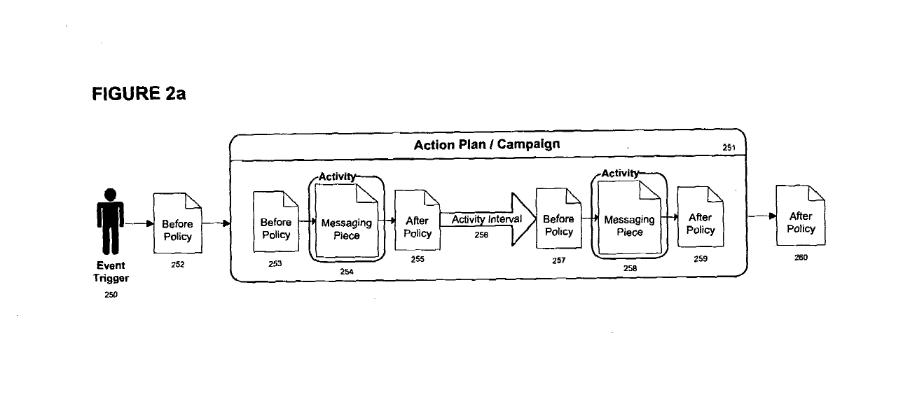

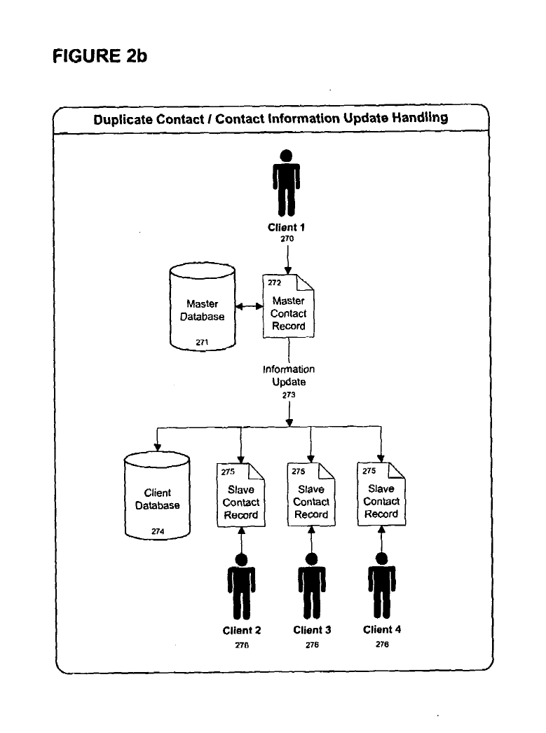

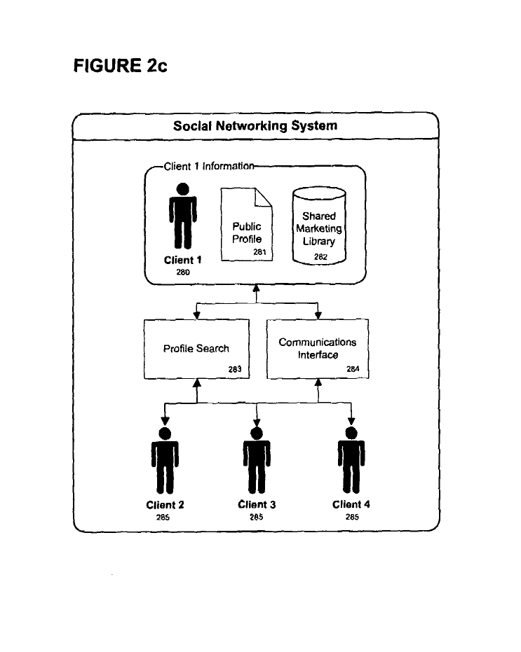

FIG. 2 is an embodiment of a sales cycle marketing system. The sales cycle marketing system may contain several subsystems 203, 207, 211, 216, 222, 229, 235, and 239) to provide functionality of the sales cycle marketing system. A User Interface Subsystem 203 provides for access to information and other components of the system. A Commerce Subsystem 207 allows for the electronic order payment processing and billing of goods and services procured through the system. A Marketing Subsystem 211 provides both a library of marketing actions, algorithms used to select such actions, and user interface infrastructure 213 to capture, store and process information resulting from those actions. A Fulfillment Subsystem 239 accepts outputs from the Marketing Subsystem and selects the appropriate vehicle through which to publish the marketing action. As the marketing action reaches the recipient via a Recipient Interface Subsystem 222, a Tracking System 216 captures interactions throughout the system and provides that information to a Reporting Subsystem 229 where additional algorithms manipulate and present the information to various functions throughout the system. A Notification Subsystem 235 receives various data from the Reporting Subsystem 229 and publishes such information through various electronic and non-electronic communications channels.

Users can interact with the various components of the system through various Application Program Interfaces (APIs) and user interfaces. The primary method of interaction with the system is through the Standard User Interface/Web-based User Interface 204. The Standard User Interface 204 is preferably a web-based platform that allows for the display and configuration of the symbiotic components that comprise the overall system and the information contained therein. Provisions will include, however, the ability to control system functions based on any user interface including mobile devices, electronic communications such as electronic mail, SMS and other means of command interfaces 205 or via third party interfaces 206. Through the User Interface Subsystem 203, and depending on their security access, a user 200 will be able to interact via entering input 201 and receiving output 202 with various parts of the system including marketing subsystems, commerce subsystems, reporting subsystems and other users (discussed further in reference to FIG. 2c).

The Commerce Subsystem 207 contains a User Invoice (and Billing) Manger 209, an Ordering System 208 and a Commerce Administrative function 210. The User Invoice Manager 209, at certain time intervals set by the system logic or initiated by an input from a user, may compute outputs such as the number of marketing actions initiated or to be initiated, the cost per action and any other pending costs and report that to the user. These outputs may then be paid manually by the user 200, or charged automatically via electronic payment methods. The user 200 will be able to preview pending bills and manipulate them by adjusting settings and information within the system. Individual invoices or billing mechanisms will be set according any number of payment plans made available to a user by the system. The Ordering System 208 allows users to augment or supplement existing marketing actions by purchasing an external marketing action (or actions) for their recipients. They can order these items through the Ordering System 208. The user 200 can also set discounts, special prices, global sale reductions, user appreciation coupons, and other such promotions, sales, or discounts as necessary for the recipients of marketing actions from time to time. Depending on the settings of a users' account, the Ordering System 208 can add the cost of the item(s) ordered to their next invoice or they can be billed immediately via electronic payment methods. The fulfillment of the order is handled either by the Marketing System 211 or by a third party service. Tracking of the successful delivery (either electronic or physical) of the order is handled by the Tracking System. The Commerce Administration function 210 provides for a central data repository to manage quantities, product or service information, attributes, and availability, price taxation and control, shipping and payment management and access data throughout the system.

The Marketing Subsystem 211 is the central repository for architecting sales stage related marketing actions and for storing and mapping out the execution of materials needed to automatically initiate marketing actions to a recipient. The marketing subsystem 211 is comprised of several symbiotic components including a Marketing Manager 212, an Information Capture Form Designer 213, an Event Planner/Scheduler 214 and a Marketing System Administrator 215. The marketing system makes use tagging (assigning meaningful, content-relevant keywords and phrases that can be searched and indexed to identify objects and data throughout the system). The marketing subsystem 211 has tags that are available depending on the user type, and the user 200 can create their own from any tagging interface within the system. Tags may be split into multiple classes that are further segmented by the user type: System-wide tags, can be used on any object, Client-specific tags, can be defined by the client and used on any object, Object-level system-wide tags, can be used on a specific object, Object-level client-specific tags, can be defined by the client and used only on the object for which they were defined. In addition the marketing subsystem 211 will allow the attachment of Notes to any individual object or object type within the system. Notes comprise Title (Note Subject), Message, Note Type (Uses Tagging Construct), Timestamp (exact time when note was created), Applicable tags to help identify the note. Notes can be system-wide (based on user type) or be user-specific.

The Marketing Manager 212 provides for the ability to define any sales stage sequence and any marketing actions within those stages (i.e. the organization of actions). It also provides the ability to define and store marketing concepts, to which can be joined to actual marketing actions, along with information about those actions (for example, the action purpose, cost guidance, and other rules governing when the marketing action could be used), and variable data (such as images, text, sound, or design structures) that the marketing manager will retrieve in order to compose a final action(s), regardless of fulfillment medium. Designs, content or data for the purposes of composing a marketing action or fulfillment channel (web page/form), creating reports, tracking tools or user/sender, response capabilities (unique links, email addresses, phone numbers, etc.) or recipient information can be stored resident to the system or accessed via an external data source. A design may be pre-defined, created or edited via the marketing manager 212 with thorough revision tracking. The choice of which marketing concept to use can be based on any of the information tracked and reported by the Tracking System 216, including user input and profiles, recipient interactions, and any database information (customer value, responses, etc.). Graphical interface may include drag and drop structures. The database may contain a user's customer or recipient records. The system may include visible or non-visible pre-processing functions such as address verification, duplicate record detection, email address or cell phone validators, on-line presence detection, IP-look ups and other functions to increase the accuracy of records needed to maximize the output success of any given marketing piece. The system also allows users to rate their success expectations of a marketing action before and after it is executed, and this drives user-specific optimization algorithms based on preferences and actual results. The marketing manager has the ability to automatically create a library of varying marketing actions and materials or information capture properties (prepared for any fulfillment channel) off of a core set of user information including but not limited to branding assets, preferences and more.

The Information Capture Form Designer 213 provides the ability to easily create and publish forms for information capture when a recipient responds to a marketing action. Exemplary forms include surveys, referral capture, scheduling systems, and commerce systems to facilitate information capture after a marketing action has taken effect and the recipient responds.

The Event/Action Plan Manager 214 provides the ability to assign sequence and/or frequency of marketing actions to automate execution. This can be static (assigned to an action—every Thursday), serial (following a previous step), or variable (if X, then Y), self learning systems or any other optimization algorithms. The system will also employ policy management FIG. 2a (discussed below) which provides the ability to intercept and alter existing scheduled algorithms based on additional data inputs from outside the system.

The Marketing System Administration function 215 provides for a user or a central function the ability to create a customized marketing system and to access data throughout the system. Through this administrative system, a user can transfer, duplicate, change credentials or manipulate other users, marketing actions and recipient information. The function 215 also provides a suppression list manager. This is a list of email addresses, phone numbers, physical addresses or other wildcard matches that have been selected to not receive future communication from a campaign or from the system. The email addresses, phone numbers or physical addresses are linked with the original sources, but new ones can be added that are not linked to any existing records (for example, if you wanted to block all emails from being sent to *@whitehouse.gov). Suppression lists may use wildcard matching for specific sender information matching. When a “send” event occurs for a messaging piece, if that person matches the master Suppression list it will record that fact (that the send did not occur) for that specific reason which may be later reported upon. A user can also track any referrals, user sponsors and incentive information that could affect billing based on any user referrals of other users of the system. The function will provide reporting and communication capabilities such that system administrators, representing or not representing users, may interact with the system around such information that may include but not be limited to billing, fulfillment, user or marketing action information.

The system also has the ability to create any number of accounts or user profiles for users/senders based on user provided information. The function 215 also includes an information repository of links or files containing information useful to users or recipients and will also accommodate information surrounding individual users acting as teams or a company as it relates to reports, marketing actions and fulfillment policies and algorithms. Users may be assigned credentials which govern visibility to certain features and access to certain information and billing/fulfillment policies. The system 215 provides for encryption/decryption and other security mechanism of files transferred into, out of and throughout the system. The system 215 may provide parsing, sorting and filtering policies to smooth the process of getting unstructured information into the system 215. Customers and associated information can be classified and segmented by a system-wide tagging construct. The information stored for this purpose is in one embodiment classified into the following entities: Recipient (Recipient type—Leads, Personal Contacts, Opportunities, etc.—all defined using the tagging construct, same with Stage, etc.), Groups (used to segment Contacts and Groups can have their own permissions settings), Transactions—a standalone object that is used to link Recipient information or Groups together with additional user-definable information (financial data, dates, etc), Lists—SQL queries that utilize tags and other customer and transaction fields to segment the data. Lists are used to assign highly-specific (or very vague) groups of Recipient information to specific Action Plans (defined in the Event/Action Manager). Lists may also consist of special API connections to remote databases or APIs.

Once the Marketing System 211 initiates a marketing action, the design and/or information populating the marketing actions are assembled and passed to the appropriate fulfillment channel within the Fulfillment System 239. These fulfillment channels may include electronic communication outputs 242 such as telephone, fax, instant messaging, SMS, email 241, direct mail via the printer user 243 (which could be automated), or third party services 240 which will use the marketing action output to execute a service as input sent to a recipient 244. The information populating the design may include unique, system generated codes, or software code to assist in the tracking of the marketing action from time to time. The fulfillment channel may be resident in the system or external to the system. Provisions exist for any fulfillment channel to existing in any geographic location and to confirm receipt of materials, report successful execution, and other any other reasons for communication with the Marketing System 211. This information is then made available to the Reporting Engine 230, where it can be used to drive decisions made by the other Systems/Subsystems. The selection of which channel may be predetermined by the Marketing System Administration function 215 or by the Event/Action Plan Manager 214 but further selection algorithms may be resident in the fulfillment system 239 to provide for further fulfillment channel selection such as geographic location, cost, accuracy or other fulfillment channel information.

The Recipient Interface 222 provides for interaction with the system for the recipient user 228 of marketing actions and fulfillment channels by accepting information from a recipient 225 and sending information to a recipient 226. Recipient input is received into the overall system occurs through various APIs and user interfaces. Web-based interfaces 223 may include series of questions in a manner determined by the User 200 using the Survey/Form Designer 213 and delivered to the customer via the Fulfillment System 239. The answers to the questions may be delivered into the Tracking System 216 where they can be utilized in the various rule-based decision making processes available throughout the Event/Action Plan Manager 214 and through the Reporting System 229 presented to the user that enable him to alter the system configuration based on the presented information if necessary. In some cases these survey forms may accept a unique code that has been previously provided to the customer via one of the fulfillment methods. This unique code allows the potential for the survey to be customized for that specific customer, as well as providing information to the Tracking System that links the unique code, the user, and recipient. Other instances may include a form to capture updated information, referrals, schedule reservations or other commerce based information. Recipients may also interact with the system via electronic and non-electronic Command Interfaces (a.k.a. communication channels) 224 such as telephone, fax, instant message, SMS message, email, and direct mail.

The Tracking System 216 is the central point for all input made to the system by users, fulfillment channels and the recipient of any output from the system. The Tracking System 216 records the data and makes it available in summarized form to the Reporting System 229. Data may be received through special asynchronous interfaces depending on the information required. Exemplary interfaces may include marketing communications tracking 217 whereby information related to marketing actions delivered by electronic communications may be made both manually by the user of the system and automatically by the system itself and may include response communications such as electronic mail, telephone calls, faxes, instant messages, clicking on links, SMS messages, etc. Information such as time, date, opens, interaction, forwards, opens/receipts or non-opens/non-receipts for all marketing actions may be tracked. The system 216 will be able to generate unique tracking mechanisms in each individual marketing piece to facilitate such tracking regardless of response choices by the recipient. The system 216 will also track information surrounding the interaction with information capture web interfaces 218 such as scheduling forms, survey forms, and may also track commerce capabilities 219. The Tracking System 216 may also accept/retrieve information from third party services 220 and external data resources. After a recipient responds, and the system 216 logs a unique response identifier for the information surrounding that marketing action and response (time, sender, recipient, etc.), the recipient may be required to continue action for a variety of reasons. This continuance of action may result in additional information captured such as web forms, voice call recordings, email exchanges, SMS exchanges and more. The information captured as a result of the response will be automatically categorized and either processed automatically against a sender's core records or staged for further manual processing. The Tracking System Administration 221 function provides for access, management, and structure the data collected by the Tracking System 216.

The Reporting System 229 summarizes the data collected by the Tracking System 216 and makes that information available to the User 200 through a series of predefined and customizable reports. These reports are available for view through a standard user interface or can be scheduled for transmission to a destination via the Notification System 235. Users will be able to conduct activities specific to reports including but not limited to viewing, printing, exporting 234, importing, filtering, searching, analyzing, and interacting with information. Special reporting functions and algorithms are also made available that facilitate additional value within the system. Each marketing action, collection of marketing actions, fulfillment channels, recipients and users are given an effectiveness score 231 which is an amalgamation of historical data, averages, summary and rankings versus similar entities classified accordingly. This effectiveness score allows for a benchmark to facilitate rankings and comparisons throughout the system. A customer value index 232 provides for a mechanism for understanding the value of a customer by calculating the total dollars contributed to a business by a recipient individually, the total dollars contributed to a business by the recipients referrals, their historical attempt at referrals, their history and metrics of interacting with marketing actions and a users total investment in that recipient over time. The system also makes available through the User Interface 203 a summary of all potential and existing recipient data to the user. A Predictive Planning function 233 examines the data associated with all users and marketing actions throughout the system to suggest additional marketing actions that may optimize a user's current allocation of marketing action resources or budget. Once chosen, the user will also be able to choose various time intervals and the system will use system wide and marketing action history for the user's current portfolio of marketing actions to calculate economic or marketing metric benefits over time.

The Notification System 235 is similar to the Marketing System's Event Manager and Fulfillment System, however, it is used to provide information notifications to the user (or associated with the user) of the system via input to user 245. Notifications can include, but are not limited to: Event Reminders (birthdays, anniversaries, new records added, etc.), System Event Reminders (marketing actions have been completed, Billing Event Reminders (invoices due, invoices requiring approval, etc.), Tracking System Information Rule-Based Reminders (notices when certain conditions are met within the Tracking System, such as if a specific customer has responded to or opened a piece, filled out a survey, or any other previously-defined conditions are matched) and Reports (previously scheduled reports, both custom and prepackaged, displaying the efficacy of the system). Notifications can be made via physical and electronic means, internal or third party, and may include email 236, printed materials, telephone calls, faxes, instant messages, and/or SMS messages 237.

FIG. 2a illustrates Action Policies, which are used by the Event/Action Plan Manager 214 and are further used by custom programs that can be attached before and after activities and before and after Action Plans. Action Policies can pause or halt execution of Actions or Action Plans as well as modifying their information/output. Policies can also set dynamic variables that can be called upon in marketing Actions and other locations. Action Policies may access all the data that is used for the Activity and Action Plan (including the Messaging) and may modify it dynamically based on any criteria, including but not limited to external (through SQL queries to remote databases, for example, or interfacing with remote APIs). Policies preferably run in their own “sandbox” for security reasons. The sandbox applies across the entire Action Plan; so Policies can set variables that can be accessed and used by other policies within the same Action Plan. The effect of the Action Plan/Campaign may be a new policy, referred to as an After Policy 260.

Accordingly, FIG. 2a illustrates how an Event Trigger 250 triggers an Action Plan 251. Thus, programs, called Action Policies, can comprise a Before Policy 252 and an After Policy 260 which is the outcome of an Action Plan 251. Action Policies may have access to the data that is used for the Action Plan 251 (including any associated Messaging) and can dynamically pause or halt the execution of the active Action Plan, create or alter variables that can be called upon in marketing Actions and other locations within the system, as well as change the Action Plan's parameters.

Similarly, a chain of Activities (surrounding Messaging Pieces 254 and 258) that make up an Action Plan 251 can be manipulated by Action Policies comprising Before Policies 253, 257 and After Policies 255, 259, and even by the choice of Activity itself. Action Policies can also manipulate the Activity Interval 256 (a time period) that occurs between sequential Activities (each comprising a Before Policy, Messaging Piece, and an After Policy) within an Action Plan, reducing or extending its duration.

FIG. 2b provides for Duplicate Contact and Contact Information Management and includes an opt-in duplicate contact/information update system that will allow better management of contact information across all users of the marketing system. The first time a contact is created, their record will be considered a “Master Contact” 272 and the user that created the Contact will be the “owner” shown as client 1 (270). Master Contact records will be stored in the system-wide master database 271. When another user adds a contact that has key pieces of matching, reference-able information—phone number, name fields, etc., an internal link is made to the Master Contact record (the data is still managed separately as two entries) and the linked Contact is considered the “Slave” Contact Record 275 associated with a particular client (collectively, the clients 1-3, (276) and this information is stored in a client database 274. The user is given the option of filling in any missing data from the Master Contact record if any exists. If the client has entered in new data that is not available in the Master Contact record, a notification is sent to the owner of the Master Contact record stating that new information is available for the Contact. If the owner so chooses, he may implement the changes. If the owner implements changes or makes them on his own, notifications are sent to all the Slaves whose contact information is different from the change the owner just made, and if the owners of the Slave Contact information approve it, their information is updated 273 to match the Master Contact's information. If a user leaves, they will forfeit their ownership of any Master Contacts and these will revert to control by the most active owners of the Slave Contacts for those records (or, if there are no Slave Contacts, ownership will revert to the system administrators). One benefit of such a system is that it puts the onus on the users themselves to keep their records updated, and also lets everyone share in the benefit of an updated record. In addition, Users must know basic information about the Recipient in order to access it. System-wide restrictions refuse the execution of the same marketing action to the same Contact within a variable timeframe. When clients are assigning their Contacts to Action Plans, these exceptions are noted to the user and they have the option of creating a new Action Plan that does not include the restricted piece(s) and assigning that Contact to that, or by not doing anything, the Contact will automatically not receive that piece of marketing due to the system restrictions.

FIG. 2c illustrates a social networking system resulting from use of the system. A user (client 1) 280 has a profile 281 in the system and a library of marketing actions and associated metrics 282. The collection of the client 280, a profile 281 and selected marketing library information 282 comprise a user 1 information. Each user profile may be made public or private. In addition, each user may be categorized as a user or a fulfillment channel or a marketing action provider. Public profiles can choose to make various elements of their user profile available for review and search 283 to other users (collectively, clients 2-4 (285))—allowing for the communication between like professionals and users. Metrics associated with marketing actions, services and materials will be accumulated against the profiles. These elements will be used to benchmark one user and their marketing materials against others. Each user can also denote whether their chosen marketing actions or services or collection of marketing actions (campaigns) or services are eligible for use or license by other users. A communication infrastructure 284 is made available between users and the commerce system will facilitate the license or purchase of marketing action inputs from one user profile to another.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A system for managing marking and sales processes, comprising:
a user interface that receives user input and generates output for a user;
a commerce subsystem that allows a user to order marketing events, an invoice manager that invoices the user based at least in part on marketing events;
a marketing subsystem that manages a recipient contact, provides marketing forms, and manages the timing of the recipient contact;
a fulfillment subsystem that generates the recipient contact;
a recipient interface that receives an indication of a recipient interaction;
a tracking subsystem that that captures recipient-generated events;
a reporting subsystem that generates scores and indexes indicating marketing effectiveness; and
a notification subsystem that notifies the user of information generated by any of the commerce subsystem, marketing subsystem, or tracking subsystem.
